(19) United States
(12) Patent Application Publication
(10) Pub. No.: US 2025/0209514 A1
(43) Pub. Date: Jun. 26, 2025

(54) INFORMATION PROCESSING APPARATUS, INFORMATION PROCESSING METHOD, AND NON-TRANSITORY COMPUTER READABLE MEDIUM

(71) Applicant: Rakuten Group, Inc., Tokyo (JP)

(72) Inventor: Meng ZHAO, Tokyo (JP)

(73) Assignee: Rakuten Group, Inc., Tokyo (JP)

(21) Appl. No.: 18/954,737

(22) Filed: Nov. 21, 2024

(30) Foreign Application Priority Data
Dec. 22, 2023 (JP) 2023-216709

(51) Int. Cl. G06Q 30/0601; G06Q 30/0201

(52) U.S. Cl. CPC G06Q 30/0631; G06Q 30/0201

(57) ABSTRACT

An information processing apparatus acquires a list of sales page identification information identifying each sales page for one or more products associated with each user, converts the list of sales page identification information into a list of product identification information identifying a product, generates a recommended product list including recommended product identification information identifying each of one or more products to be recommended to the user, based on the list of product identification information, determines a sales page for each of the one or more products to be recommended to the user, based on one or more pieces of recommended product identification information included in the recommended product list.

### CROSS-REFERENCE TO RELATED APPLICATION(S)

This application claims priority to Japanese patent application No. 2023-216709, filed on Dec. 22, 2023; the entire contents of which are incorporated herein by reference.

### TECHNICAL FIELD

The present invention relates to a technology for determining a sales page for a product to be recommended to a user.

### BACKGROUND ART

Electronic commerce (e-commerce), in which products are sold online via the internet, has been actively conducted in recent years. Such e-commerce is conducted, for example, via e-commerce sites such as an e-commerce mall (a mall-type e-commerce site) that operates an online shopping mall with a plurality of stores. Users can view and purchase desired products without having to physically visit multiple stores and without worrying about time by accessing the e-commerce site from a personal computer (PC) or a mobile device such as a smartphone.

For the purpose of sales promotion on an e-commerce site, a technology has been proposed that specifies products in which a user is interested based on a history of action on product sales pages, such as a purchase history and a browsing history of the user, and determines products to be recommended to the user based on the specified products. For example, JP 2022-172545A discloses a method of determining as a recommended product a second product in a predetermined relationship with a first product specified based on the purchase history of the user.

JP 2022-172545A is an example of related art.

### SUMMARY OF THE INVENTION

When determining a recommended product for a user based on the user's history of actions on sales pages, it is important to appropriately associate information regarding the actions (action information) with identification information regarding products (product identification information) to specify a product in which the user is interested. If a plurality of stores at an e-commerce mall sell the same product, this product may be displayed and sold on different sales pages of the respective stores. If the same product is sold on different sales pages, the action information may not be appropriately associated with the product identification information. That is, the action information regarding actions of the user on those different sales pages may not be associated with the same product identification information, but with different product identification information, which could result in the action information not being appropriately associated with the product identification information. As a result, there is a concern that the sales pages for the products to be recommended to the user cannot be appropriately determined.

The present invention has been made in view of the foregoing problem, and aims to provide a technology for appropriately determining a sales page for a product to be recommended to a user.

To solve the foregoing problem, one aspect of an information processing apparatus according to the present invention includes: an acquisition unit configured to acquire a list of sales page identification information identifying each sales page for one or more products associated with each user; a conversion unit configured to convert the list of sales page identification information into a list of product identification information identifying a product; a generation unit configured to generate a recommended product list including recommended product identification information identifying each of one or more products to be recommended to the user, based on the list of product identification information; and a determination unit configured to determine a sales page for each of the one or more products to be recommended to the user, based on one or more pieces of recommended product identification information included in the recommended product list.

To solve the foregoing problem, one aspect of an information processing method according to the present disclosure includes: acquiring a list of sales page identification information identifying each sales page for one or more products associated with each user; converting the list of sales page identification information into a list of product identification information identifying a product; generating a recommended product list including recommended product identification information identifying each of one or more products to be recommended to the user, based on the list of product identification information; and step of determining a sales page for each of the one or more products to be recommended to the user, based on one or more pieces of recommended product identification information included in the recommended product list.

To solve the foregoing problem, one aspect of a non-transitory computer readable medium storing an information processing program for causing a computer to perform information processing, the information processing includes: acquisition processing of acquiring a list of sales page identification information identifying each sales page for one or more products associated with each user; conversion processing of converting the list of sales page identification information into a list of product identification information identifying a product; generation processing of generating a recommended product list including recommended product identification information identifying each of one or more products to be recommended to the user, based on the list of product identification information; and determination processing of determining a sales page for each of the one or more products to be recommended to the user, based on one or more pieces of recommended product identification information included in the recommended product list.

According to the present invention, a sales page for a product to be recommended to a user can be appropriately determined.

A person skilled in the art will be able to understand the above-stated object, aspect, and advantages of the present invention, as well as other objects, aspects, and advantages of the present invention that are not mentioned above, from the following modes for carrying out the invention by referring to the accompanying drawings and claims.

### BRIEF DESCRIPTION OF THE DRAWINGS

FIG. 1 shows an example configuration of an information processing system according to an embodiment.

FIG. 2 shows an example functional configuration of an information processing apparatus according to a first embodiment.

FIG. 3 shows an example of a time-series sales page ID list.

FIG. 4 shows an example hardware configuration of the information processing apparatus according to the embodiment.

FIG. 5 is a flowchart of processing performed by the information processing apparatus according to the embodiment.

FIG. 6 shows an example of a per-user sales page ID list.

FIG. 7 shows an example of a per-user product ID list.

FIG. 8 shows an example of a per-user recommended product ID list.

FIG. 9 shows an example of a per-user recommended sales page ID list.

FIG. 10 shows an example functional configuration of an information processing apparatus according to a second embodiment.

FIG. 11 is a flowchart of genre determination processing according to the second embodiment.

FIG. 12 is a conceptual diagram showing the flow of data in determining top four genre IDs.

FIG. 13A shows an example screen including sales pages for selling a plurality of products in an e-commerce mall.

FIG. 13B shows an example screen including a sales page for selling a product in the e-commerce mall.

FIG. 13C shows another example screen including sales pages for selling a plurality of products in the e-commerce mall.

FIG. 14 shows an example functional configuration of an information processing apparatus according to a fourth embodiment.

FIG. 15 shows another example of a per-user product ID list.

### EMBODIMENTS OF THE INVENTION

Embodiments of the present invention will now be described in detail with reference to the accompanying drawings. Out of the component elements described below, elements with the same functions have been assigned the same reference numerals, and description thereof is omitted. Note that the embodiments disclosed below are mere example implementations of the present invention, and it is possible to make changes and modifications as appropriate according to the configuration and/or various conditions of the apparatus to which the present invention is to be applied. Accordingly, the present invention is not limited to the embodiments described below. The combination of features described in these embodiments may include features that are not essential when implementing the present invention.

### First Embodiment

### Configuration of Information Processing System

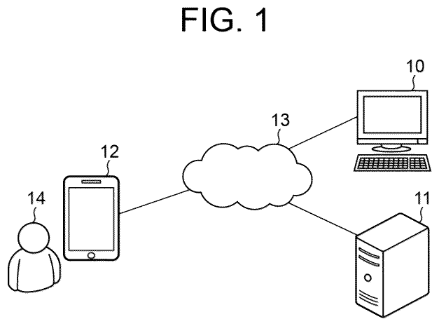

FIG. 1 shows an example configuration of an information processing system according to the present embodiment. The information processing system includes an information processing apparatus 10, an e-commerce site server 11, and a user device 12. The information processing apparatus 10, the e-commerce site server 11, and the user device 12 can communicate with each other via a network 13. The network 13 may include the internet as well as any other type of network such as an intranet, local area network (LAN), wide area network (WAN), or mobile communication network. Although FIG. 1 shows one user device 12, the information processing system is configured to include a plurality of user devices having the same functionality as the user device 12. In the present disclosure, the plurality of user devices are collectively referred to as the “user device 12”. The user device 12 is operated by a user 14. In the present disclosure, the terms “user device” and “user” may be understood as synonymous.

The e-commerce site server 11 is a server device that operates an e-commerce mall (mall-type e-commerce site), which is an online shopping mall with a plurality of stores. Specifically, the e-commerce site server 11 operates an e-commerce mall, which is a shopping mall constituted by sales pages (webpages) for products sold by a plurality of stores (merchants). The e-commerce site server 11 can be accessed by the user device 12 via the network 13 and provide the user 14 with various services related to shopping at the e-commerce mall. For example, in response to the user accessing the e-commerce mall and performing an action such as purchasing or viewing a sales page for a certain product, the e-commerce site server 11 provides a service related to the product to the user 14. Further, the e-commerce site server 11 can acquire (collect) and manage information regarding the sales page for the product on which the user 14 has performed an action at the e-commerce mall. Note that the e-commerce site server 11 is not limited to a server device and may alternatively be realized by a mainframe or the like.

The user device 12 can be operated by the user 14 to access the e-commerce site server 11 and receive various services in the e-commerce mall provided by the e-commerce site server 11. For example, the user 14 can operate the user device 12 and access the e-commerce mall to view sales pages for various products provided by the e-commerce mall and purchase the products. When using the services in the e-commerce mall, the user 14 registers information regarding the user 14 (hereinafter also referred to as user attributes). For example, the user 14 sets a user ID (user identification information) that identifies the user 14 and is associated with the user attributes of the user 14, and logs in using this user ID to use the services in the e-commerce mall. By setting the user ID, the user 14 can also use the services in the e-commerce mall from a user device that is connected to the network 13 and different from the user device 12.

The user attributes include factual attributes of the user. The factual attributes of the user include an IP address of the user device, the address and name of the user, the number of a credit card held by the user, demographic information of the user (demographic user attributes such as gender, age, area of residence, occupation, and family composition), and the like. The factual attributes of the user may also include a registration number and a registered name for using web services including the e-commerce mall (web services related to the e-commerce mall). The factual attributes of the user may also include information related to a use history, a search history, a product purchase history (including purchase results) for web services including the e-commerce mall D, and points that can be accumulated by using the services. Thus, the factual attributes of the user may include any type of information, including information associated with the user device or the user themself and information related to the use of web services including the e-commerce mall.

The user attributes may also include estimated attributes of the user. The estimated attributes of the user may be estimated based on the factual attributes of the user by a trained user attribute estimation model, for example. The estimated attributes of the user may include tastes of products in which the user is interested, and lifestyle.

The user device 12 is, for example, a device such as a smartphone or a tablet, and can communicate with the e-commerce site server 11 and the information processing apparatus 10 via the network 13. The user device 12 has a display (display surface) such as a liquid-crystal display, and the user 14 can perform various operations using a graphical user interface (GUI) installed on the display. The operations include various operations on contents such as images displayed on a screen, including tapping, sliding, and scrolling using a finger, a stylus, or the like. The user device 12 may have a separate display.

The information processing apparatus 10 acquires information related to product sales pages collected by the e-commerce site server 11, and determines a sales page for a product to be recommended to the user 14 based on the acquired information. Specifically, the information processing apparatus 10 first acquires a sales page ID list including sales page IDs that identify sales pages for products associated with the user 14, and converts the sales page ID list into a product ID list including product IDs that identify products. Next, the information processing apparatus 10 generates a recommended product list including recommended product IDs that identify products to be recommended to the user 14 based on the product ID list, and determines sales pages for the products to be recommended to the user 14 based on the recommended product IDs. Information regarding the determined sales pages for the products is provided to the e-commerce site server 11, which can then provide the sales pages to the user device 12 in accordance with the information. Although the information processing apparatus 10 and the e-commerce site server 11 in FIG. 1 are separate devices, the information processing apparatus 10 may alternatively include the functionality of the e-commerce site server 11.

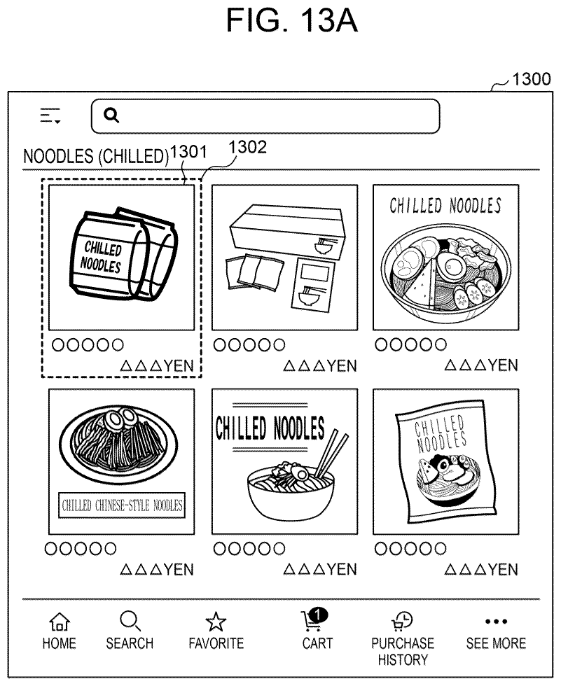

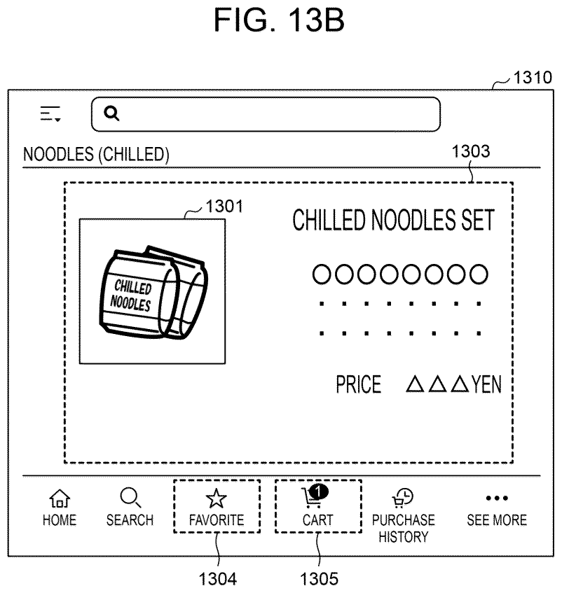

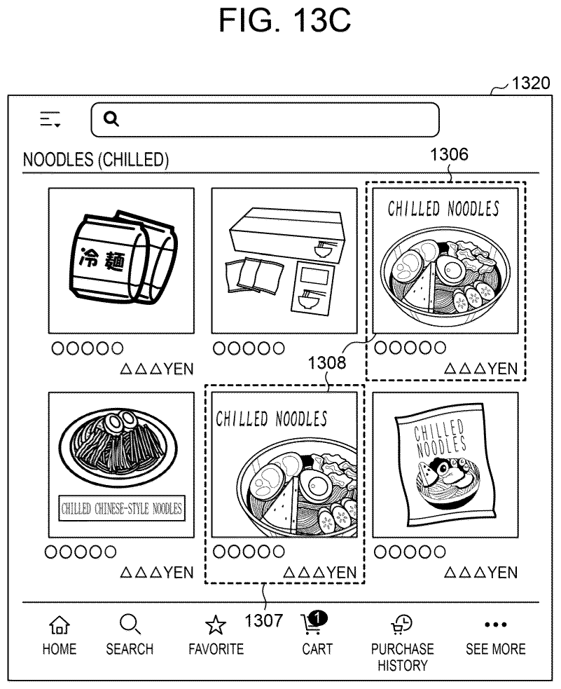

FIG. 13A shows an example of a screen 1300 that includes a plurality of sales pages of the e-commerce mall provided by the e-commerce site server 11. The plurality of sales pages are managed and operated by different stores (merchants). Each sales page is therefore associated with the store of a corresponding product being sold on the sales page. Each sales page on the screen 1300 includes an image related to a product being sold and information (description, price etc.) related to the product. Taking a sales page 1302 as an example, the sales page 1302 is a sales page that sells a product 1301. Specifically, the product 1301 is an image of the product being sold on the sales page 1302, and this image is referred to as a “product” in this disclosure. The image on a sales page need only be an image that illustrates the products being sold.

### Functional Configuration of Information Processing Apparatus

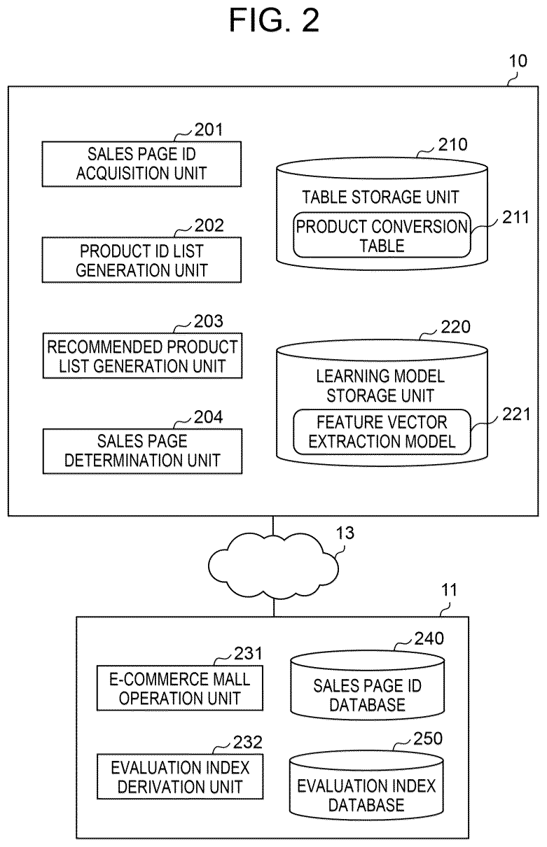

FIG. 2 shows an example of a functional configuration of the information processing apparatus 10 according to the present embodiment. As its functional configuration, the information processing apparatus 10 includes a sales page ID (sales page identification information) acquisition unit 201, a product ID (product identification information) list generation unit 202, a recommended product list generation unit 203, a sales page determination unit 204, a table storage unit 210, and a learning model storage unit 220.

The table storage unit 210 can store a product conversion table 211 for converting a sales page ID to a product ID. The product conversion table 211 is a table that associates a product ID, which identifies a product being sold in the e-commerce mall, with sales page IDs, which identifies one or more sales pages that sell the product. The same product ID is assigned to the same product. Since the same product may be sold on different sales pages, there are cases where different (a plurality of) sales page IDs are associated with one product ID in the product conversion table 211. In the present embodiment, it is assumed that one sales page ID is not associated with a plurality of product IDs.

The learning model storage unit 220 can store a trained feature vector extraction model 221. The feature vector extraction model 221 is a machine learning model that extracts (derives) a vector representation of a user of a user ID based on past actions linked to this user ID. Specifically, the feature vector extraction model 221 is a machine learning model that outputs a vector representation of a user of a user ID in response to input that is a list (e.g., information indicating the list) of product IDs of products for which the user of the user ID has previously performed an action. This vector representation corresponds to a representation obtained by vectorizing product IDs in which the user has shown an interest. The feature vector extraction model 221 is a matrix factorization (MF)-based or natural language processing (NLP)-based model. The MF-based model is a model that decomposes an evaluation value matrix of m (number of rows)×n (number of columns) (m and n are integers greater than or equal to 2) into two matrices by reducing the dimensionality using collaborative filtering. The NLP-based model is a natural language processing model that converts words into a vector representation, such as Word2Vec. The feature vector extraction model 221 is re-trained as needed by a processing unit (not shown) of the information processing apparatus 10 or an external device.

Note that the entire information processing apparatus 10 need not necessarily be one device, and may alternatively be constituted by a plurality of devices. For example, a portion of the information processing apparatus 10 may be provided in an external server device, such as the e-commerce site server 11. In this case, the functionality described in the present embodiment is realized by cooperation between the information processing apparatus 10 and the external server device.

FIG. 2 also shows an example of a functional configuration of the e-commerce site server 11 associated with the present embodiment. The e-commerce site server 11 is connected to the information processing apparatus 10 via the network 13. The e-commerce site server 11 in FIG. 2 has an e-commerce mall operation unit 231, an evaluation index derivation unit 232, a sales page ID database 240, and an evaluation index database 250, which are functional constituents associated with the present embodiment.

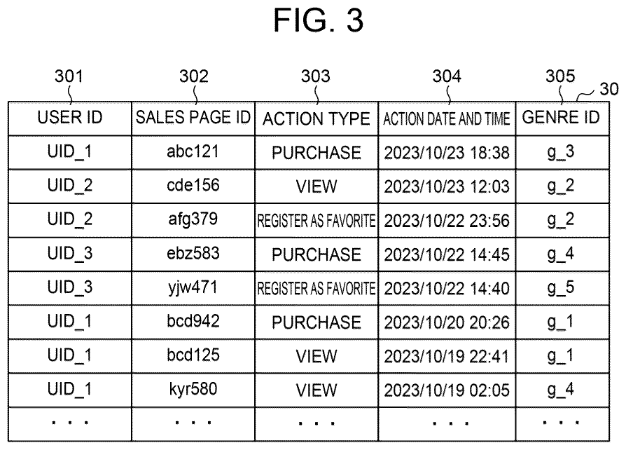

The e-commerce mall operation unit 231 operates the e-commerce mall, in which a plurality of stores sell products online. For example, the e-commerce mall operation unit 231 can create a plurality of sales pages based on product information provided by the stores and provide the created sales pages to the user device 12 connected via the network 13. The e-commerce mall operation unit 231 can also provide the user device 12 with a service corresponding to the type of action performed on a sales page for a product from the user device 12. The e-commerce mall operation unit 231 can also provide a sales page specified by the information processing apparatus 10 to the user device 12. In response to the user device 12 performing a specific action on a sales page for a product, the e-commerce mall operation unit 231 stores the sales page ID in association with the user ID in the sales page ID database 240. An example of the sales page ID will be described later with reference to FIG. 3. The evaluation index derivation unit 241 derives an evaluation index (marketing index) associated with each sales page in the e-commerce mall provided by the e-commerce mall operation unit 231. This evaluation index is an evaluation index for a product being sold on a sales page or a store (merchant) that sells the product, and may include a CVR (conversion rate) of the sales page. The conversion in the CVR in the present embodiment is assumed to be a purchase of a product, but may alternatively be a click on the product in another embodiment. The evaluation index may also include an evaluation score given by the user to the sales page, and a rank of this evaluation score (position in the ranking). The evaluation score may include a numerical representation of the user's evaluation, comments, or level of recommendation of a sales page, a store, or a product.

The e-commerce mall operation unit 231 adds a sales page ID in time-series to the sales page ID list stored in the sales page ID database 240 each time a predetermined action is performed by the user on a sales page for a product in the e-commerce mall. That is, the sales page ID list is generated each time the predetermined action is performed. The sales page ID list stored in the sales page ID database 240 will be hereinafter referred to as a time-series sales page ID list. FIG. 3 shows an example of a time-series sales page ID list 30 stored in the sales page ID database 240. The time-series sales page ID list 30 is a list of sales page IDs collected each time any of predetermined actions is performed by any of three users on sales pages for a plurality of products in the e-commerce mall. As an example, the time-series sales page ID list 30 includes columns of user ID 301, sales page ID 302, action type 303, action date and time 304, and identified genre ID (genre identification information) 305 as its constituent elements. The genre ID 305 indicates a genre of a product being sold on a sales page identified by the sales page ID 302, and is associated with each product page.

The user ID 301 is information that identifies each of the three users, and is UID_1, UID_2, or UID_3. Each UID of the user ID 301 is associated with user attributes. For example, UID_1 is associated with user attributes registered by a user identified by UID_1 when using a service in the e-commerce mall. The sales page ID 302 is information that identifies a sales page (webpage). As an example, the sales page ID 302 is constituted by a character string that identifies a sales page for a product, and may be a character string such as those shown in FIG. 3, or may be a uniform resource locator (URL). The action type 303 indicates the type of predetermined action on a sales page for a product. In the present embodiment, the predetermined action is one of “view”, “register as favorite (add to favorites)”, and “purchase”. “View” corresponds to an action of accessing (visiting) the sales page and viewing the sales page. “Register as favorite” corresponds to an action of marking and registering a product being sold on the sales page online. “Purchase” corresponds to an action of purchasing a product being sold on the sales page. Note that if the “purchase” action is performed within a predetermined time after the “view” action, only the “purchase” action may be registered. The action date and time 304 is information indicating the date and time when the action indicated by the action type 303 was performed. The time-series sales page ID list 30 is configured such that new constituent elements are placed at the top of the list in accordance with the date and time. The genre ID 305 indicates information (genre identification information) that identifies a genre of a product being sold on the sales page identified by the sales page ID 302. The genre ID 305 is used in the second embodiment.

The “view”, “register as favorite”, and “purchase” actions for a product being sold on a sales page are described with reference to FIG. 13B. FIG. 13B shows an example of a screen 1310 that includes a sales page 1303, which is displayed when a sales page 1302 is selected (activated) and accessed on the screen 1300 shown in FIG. 13A. The sales page 1302 in FIG. 13A and the sales page 1303 in FIG. 13B are both sales pages for selling the product 1301. The sales pages 1302 and 1303 are examples of sales pages for selling the product 1301, and may be configured with any other design and may be displayed on the screen in a different display method. “View” corresponds to an action of accessing the sales page 1303 and viewing information related to the product 1301. “Register as favorite” corresponds to an action of selecting (activating) on the screen 1310 a favorite button 1304 to mark and register the product 1301 online. “Purchase” corresponds to an action of selecting (activating) a cart button (a button indicating a shopping cart) 1305 on the screen 1310 to purchase the product 1301, and then performing a purchasing procedure. Note that in the present embodiment, the action type is assumed to be one of the three actions, namely “purchase”, “view”, and “register as favorite”, but there is no limitation thereto. For example, the access type may also include any other access types such as a search or a clicking on a sales page for a product.

In the information processing apparatus 10, the sales page ID acquisition unit 201 acquires a sales page ID list per user ID from the time-series sales page ID list stored in the sales page ID database 240 in the e-commerce site server 11. The product ID list generation unit 202 generates a product ID list by converting into product IDs the sales page IDs included in the sales page ID list per user ID acquired by the sales page ID acquisition unit 201. The recommended product list generation unit 203 determines one or more recommended product IDs for each user ID based on the product ID list generated by the product ID list generation unit 202, and generates a recommended product ID list. The sales page determination unit 204 determines, for each user ID, sales pages for recommended products (hereinafter also referred to as “recommended sales page”) based on the recommended product ID list generated by the recommended product list generation unit 203. Specific processing performed by the sales page ID acquisition unit 201, the product ID list generation unit 202, the recommended product list generation unit 203, and the sales page determination unit 204 will be described later.

### Hardware Configuration of Information Processing Apparatus

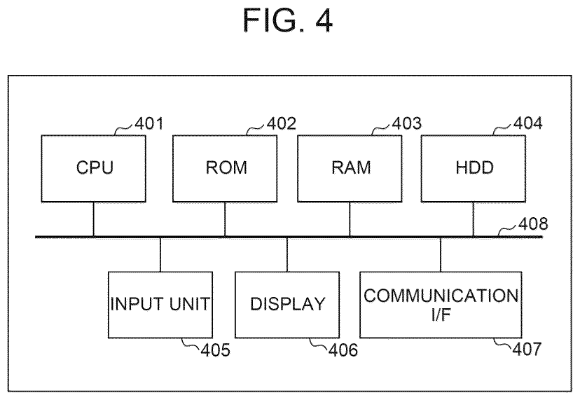

Next, an example hardware configuration of the information processing apparatus 10 is described. FIG. 4 is a block diagram showing an example of a hardware configuration of the information processing apparatus 10 according to the present embodiment.

The information processing apparatus 10 according to the present embodiment may be implemented on a single or a plurality of computers, mobile devices, or any other processing platforms.

Referring to FIG. 4, an example is shown in which the information processing apparatus 10 is implemented in a single computer. However, the information processing apparatus 10 according to the present embodiment may alternatively be implemented in a computer system that includes a plurality of computers. The plurality of computers may be communicably connected via a wired or wireless network.

As shown in FIG. 4, the information processing apparatus 10 may include a central processing unit (CPU) 401, a read only memory (ROM) 402, a random access memory (RAM) 403, a hard disk drive (HDD) 404, an input unit 405, a display 406, a communication I/F (communication unit) (interface) 407, and a system bus 408. The information processing apparatus 10 may also be provided with an external memory.

The CPU 401 centrally controls operations of the information processing apparatus 10, and controls each of the components (402 to 407) via the system bus 408, which is a data transmission line.

The ROM 402 is a non-volatile memory that stores a control program and the like required for the CPU 401 to perform processing. The program contains instructions (code) for performing processing according to the embodiment. Note that the program may alternatively be stored in a non-volatile memory such as the HDD 404 or a solid state drive (SSD), or an external memory such as a removable storage medium (not shown).

The RAM 403 is a volatile memory and functions as a main memory, work area, or the like of the CPU 401. That is, when performing processing, the CPU 401 loads a necessary program or the like from the ROM 402 into the RAM 403 and executes the program or the like to realize various functional operations. The RAM 403 may include the table storage unit 210 and the learning model storage unit 220 shown in FIG. 2.

The HDD 404 stores various types of data and information required for the CPU 401 to perform processing using a program, for example. The HDD 404 also stores various types of data and information obtained by the CPU 401 performing processing using a program or the like, for example.

The input unit 405 is constituted by a keyboard and a pointing device such as a mouse.

The display 406 is constituted by a monitor such as a liquid-crystal display (LCD). The display 406 may function as a graphical user interface (GUI) by being combined with the input unit 405.

The communication I/F 407 is an interface for controlling communication between the information processing apparatus 10 and an external device. The communication I/F 407 provides an interface with the network and performs communication with the external device via the network. Various types of data and parameters are transmitted to and received from the external device via the communication I/F 407. The communication I/F 407 of the present embodiment may perform communication via a wired local area network (LAN) or a dedicated line conforming to a communication standard such as Ethernet (registered trademark). Note that the network that can be used in the present embodiment is not limited thereto, and may alternatively be a wireless network. Examples of wireless networks include wireless personal area networks (PANs) such as Bluetooth (registered trademark), ZigBee (registered trademark), and ultra wide bands (UWBs). Examples of wireless networks also include wireless local area networks (LANs) such as Wi-Fi (Wireless Fidelity) (registered trademark) and wireless metropolitan area network (MANs) such as WiMAX (registered trademark). Examples of wireless networks also include a wireless wide area network (WANs) such as 4G or 5G. Note that the network need only be capable of communicably connecting the devices to each other and enabling communication, and the standard, scale, and configuration of communication are not limited to those described above.

At least some of the functions of each element of the information processing apparatus 10 shown in FIG. 2 can be realized by the CPU 401 executing a program. However, at least some of the functions of each element of the information processing apparatus 10 shown in FIG. 2 may be operation of dedicated hardware. In this case, the dedicated hardware operates under the control of the CPU 401.

Note that the e-commerce site server 11 has the same hardware configuration as the configuration shown in FIG. 4. Here, the RAM 403 may include the sales page ID database 240 and the evaluation index database 250 shown in FIG. 2.

### Flow of Recommended Sales Page Determination Processing

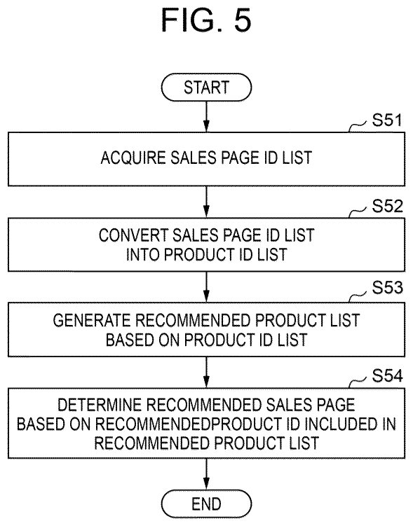

Next, recommended sales page determination processing performed by the information processing apparatus 10 according to the present embodiment will be described specifically. FIG. 5 is a flowchart of processing performed by the information processing apparatus 10 according to the present embodiment. Processing shown in FIG. 5 may be performed by the CPU 401 executing the control program stored in the information processing apparatus 10.

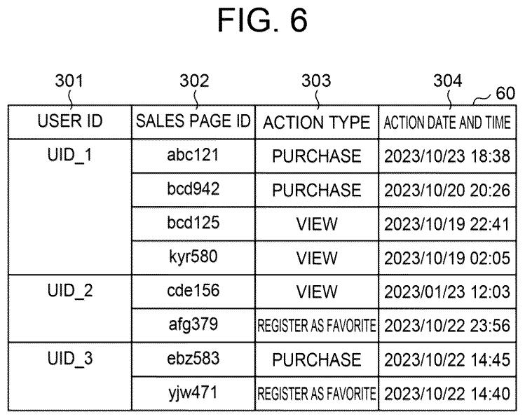

In step S51, the sales page ID acquisition unit 201 acquires the sales page ID list per user ID from the time-series sales page ID list collected by the e-commerce site server 11 and stored in the sales page ID database 240. The sales page ID list per user ID corresponds to a list of sales page IDs identifying one or more sales pages associated with the user identified by the user ID. To distinguish the sales page ID list per user ID acquired by the sales page ID acquisition unit 201 from the time-series sales page IDs stored in the sales page ID database 240, the sales page ID list per user ID will also be referred to as a per-user sales page ID list. FIG. 6 shows an example of a per-user sales page ID list 60 acquired by the sales page ID acquisition unit 201. The per-user sales page ID list 60 is a list generated by sorting sales page IDs by user ID based on the sales page ID list 30 shown in FIG. 3. That is, the sales page ID list 60 includes information of the sales page ID 302, the action type 303, and the action date and time 304 for each user ID 301.

The per-user sales page ID list 60 is a list of sales page IDs within a past predetermined time period from a predetermined timing in the sales page ID list 30. The predetermined timing may be, for example, a timing at which the sales page ID acquisition unit 201 accesses the e-commerce site server 11 to acquire the time-series sales page ID list, or a timing set by the sales page ID acquisition unit 201. Alternatively, the per-user sales page ID list may be a list that includes sales page IDs corresponding to a predetermined number of actions of each user. That is, the sales page ID acquisition unit 201 may generate and acquire the per-user sales page ID list so as to include a predetermined number of sales page IDs corresponding to a predetermined number of actions of each user. In this case, the same number of sales page IDs is listed for each user ID. Although the sale page IDs in the per-user sales page ID list 60 are sorted by user ID, the per-user sales page ID list may be generated without sorting.

Next, in step S52, the product ID list generation unit 202 converts the sales page IDs included in the sales page ID list acquired by the sales page ID acquisition unit 201 into product IDs, and generates a product ID list. In the present embodiment, the product ID list generation unit 202 converts the sales page IDs included in the sales page ID list to product IDs using the product conversion table 211 stored in the table storage unit 210. The product conversion table 211 is a table that associates a product ID of a product being sold in the e-commerce mall with sales page IDs identifying one or more sales pages that sell the product.

There are cases where the e-commerce mall sells the same product on different sales pages. Thus, there are cases where one product ID is associated with different sales page IDs in the product conversion table 211. If different sales page IDs are associated with one product ID, the product ID list generation unit 202 converts these different sales page IDs into the same product ID. FIG. 13C shows an example of a screen 1320 in which the same product is sold on different sales pages. In the screen 1320, sales pages 1306 and 1307 are sales pages that sell the same product 1308. In such a case, the product ID list generation unit 202 converts the sales page IDs of the sales pages 1306 and 1307 into the product ID of the product 1308.

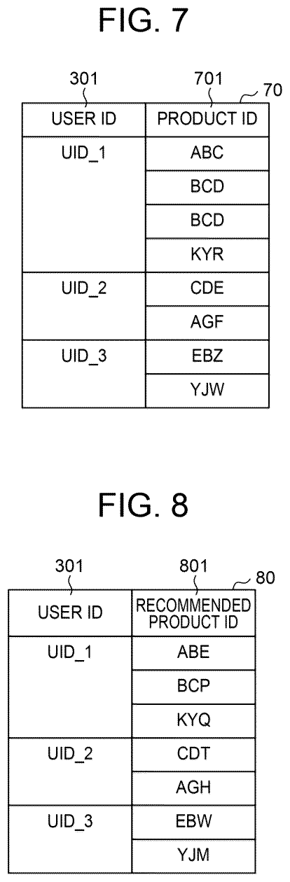

FIG. 7 shows an example of a product ID list 70 per user ID, i.e., a list of the product IDs converted by the product ID list generation unit 202 from the per-user sales page ID list 60 shown in FIG. 6. The product ID list 70 includes product IDs 701 for each user ID 301. Assume that in the per-user sales page ID list 60, the sales page IDs 302 of the user ID 301=UID_1, namely “abc121”, “bcd942”, “bcd125”, and “kyr580” correspond to the product ID=“ABC”, “BCD”, “BCD”, and “KYR”, respectively, in accordance with the product conversion table 211. In this case, the product ID list generation unit 202 lists the product IDs 701=“ABC”, “BCD”, “BCD”, and “KYR” for the user ID 301=UID_1. Here, the sales page IDs=“bcd942” and “bcd125” correspond to one product ID “BCD”, and “BCD” is listed for the respective sales page IDs.

Note that the product ID list generation unit 202 in the present embodiment converts the sales page IDs into the product IDs by referencing the product conversion table 211, but this conversion processing may be performed using any other means. For example, the product ID list generation unit 202 may perform the conversion processing using a trained machine learning model.

In step S53, the recommended product list generation unit 203 determines product IDs to be recommended (recommended product IDs) for each user ID based on the product ID list generated by the product ID list generation unit 202, and generates a recommended product ID list. In the present embodiment, the recommended product list generation unit 203 inputs to the feature vector extraction model 221 a list (information indicating the list) of product IDs of products for which the user of the user ID has previously performed any action, and acquires a vector representation of the user (hereinafter referred to as a “user vector representation”) of this user ID. The recommended product list generation unit 203 then embeds the acquired user vector representation in a common vector space. Vector representations of the product IDs being sold in the e-commerce site are embedded in this vector space. The recommended product list generation unit 203 selects (extracts) product IDs having vector representations with a high similarity to the acquired user vector representation in the vector space. For example, cosine similarity is used as this similarity. The cosine similarity is a measure of the similarity between two vectors in the common vector space. The recommended product list generation unit 203 can determine that the larger the cosine value (−1 to +1) of an angle between two vectors of the user vector representation and the vector representation of the product ID, the higher the similarity is. The recommended product list generation unit 203 calculates, in the vector space, a cosine similarity between the acquired user vector representation and the vector representation of a product ID, and determines a fixed number of product IDs with a high cosine similarity (e.g., greater than or equal to a predetermined threshold) as recommended product IDs to be included in the recommended product ID list.

Referring to FIG. 7, for example, the recommended product list generation unit 203 inputs the product ID list={ABC, BCD, KYR} to the feature vector extraction model 221 for the user of the user ID=UID_1. The feature vector extraction model 221 extracts and outputs a user vector representation of the user of the user ID=UID_1 from the input product ID list. That is, the recommended product list generation unit 203 converts the product ID list to a user vector representation using the feature vector extraction model 221. Next, the recommended product list generation unit 203 determines, as a recommended product ID, a product ID corresponding to a vector representation with a high cosine similarity (e.g., higher than a predetermined threshold) to the user vector representation in the aforementioned vector space. The recommended product list generation unit 203 performs the above-described processing for each user ID, and generates a recommended product ID list per user ID.

FIG. 8 shows an example of the recommended product ID list 80 per user ID that is generated by the above processing. The recommended product ID list 80 includes product IDs 801 for each user ID 301. For example, in the recommended product ID list 80, three recommended product IDs, namely “ABE”, “BCP”, and “KYQ” are listed as recommended product IDs 801 for the user ID=UID_1.

In step S54, the sales page determination unit 204 determines, for each user, a sales page (recommended sales page) for one or more products to be recommended based on the recommended product IDs included in the recommended product list generated by the recommended product list generation unit 203. The sales page determination unit 204 may determine a plurality of recommended sales pages for each of the one or more products to be recommended for each user, while in the present embodiment, a unique (i.e., one) recommended sales page is determined. The sales page determination unit 204 first converts one or more recommended product IDs included in the recommended product list into one or more sales page IDs by referencing the product conversion table 211. That is, the sales page determination unit 204 uses the product conversion table 211, which is for converting a sales page ID to a product ID, to convert the recommended product ID into the sales page. The sales page determination unit 204 generates a recommended sales page ID list that include the one or more converted sales page IDs.

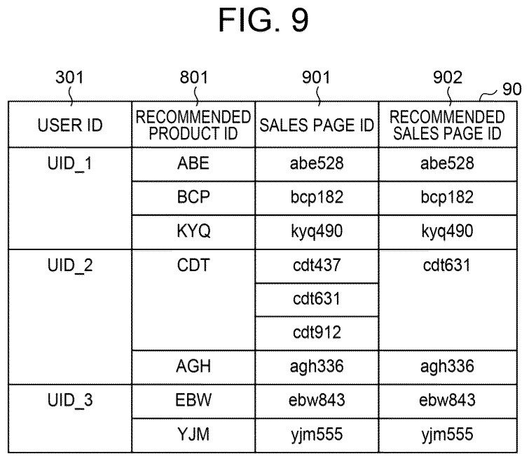

FIG. 9 shows an example of a recommended sales page ID list 90 corresponding to the recommended product IDs per user ID that is generated based on the recommended product ID list 80 shown in FIG. 8. The recommended sales page ID list 90 includes the recommended product ID 801, a sales page ID 901, and a recommended sales page ID 902 for each user ID 301. The sales page determination unit 204 specifies one or more sales page IDs (candidate recommended sales page IDs) for one recommended product ID, and determines a unique recommended sales page ID based on the one or more specified sales page IDs.

If one sales page ID (candidate recommended sales page ID) exists for one recommended product ID, this sales page ID is determined as a recommended sales page ID. For example, in the recommended sales page ID list 90, the recommended sales page ID 902=“abe528” is determined for the recommended product ID 801=“ABE” of the user ID=UID 1. Also, the recommended sales page ID 902=“bcp182” is determined for the recommended product ID 801=“BCP” of the user ID=UID_1, and the recommended sales page ID 902=“kyq490” is determined for the recommended product ID 801=“KYQ”. In this case, the sales page determination unit 204 determines the sales pages identified by the recommended sales page IDs=“abe528”, “bcp182”, and “kyq490” as recommended sales pages to be recommended (presented) to the user identified by the user ID=UID_1.

On the other hand, if a plurality of sales page IDs exist for one recommended product ID, one sales page ID selected from the plurality of sales page IDs is determined as the recommended sales page ID. For example, in the case of the user ID=UID_2, three sales page IDs exist that correspond to the recommended product ID 801=“CDT”. If a plurality of sales page IDs thus correspond to a recommended product ID, the sales page determination unit 204 may determine one recommended sales page ID based on the evaluation index associated with each sales page that is collected by the e-commerce site server 11 and stored in the evaluation index database 250. For example, when the CVR of each sales page is used as the evaluation index, the sales page determination unit 204 can select a sales page ID with a high CVR as the recommended sales page ID. A store that sells products on sales pages identified by sales page IDs with a high CVR is considered to be a highly reliable purchasing destination. Therefore, determining the recommended sales page ID based on the CVR may lead to improved usability.

Further, when a plurality of sales page IDs exist for one recommended product ID, the sales page determination unit 204 may determine the recommended sales page ID based on an evaluation index other than CVR. For example, the sales page determination unit 204 may determine the recommended sales page ID based on an evaluation score for each sales page that serves as an evaluation index. Alternatively, the sales page determination unit 204 may calculate a recommendation score based on the evaluation score and the CVR and determine the recommended sales page ID based on this recommendation score.

Thus, according to the present embodiment, the information processing apparatus 10 converts information regarding sales pages for products associated with each user in the e-commerce mall into information regarding products in the e-commerce mall. That is, the information processing apparatus 10 appropriately associates information regarding sales pages on which any action has been performed by each user with information regarding products in the e-commerce mall. The information processing apparatus 10 then determines a recommended product based on the information regarding products, and determines a unique sales page for selling the recommended product. This makes it possible to appropriately determine a sales page for a product to be recommended to each user.

### Second Embodiment

The information processing apparatus according to the first embodiment determines a sales page for a product to be recommended to each user without considering the product genre (category). The information processing apparatus according to the present embodiment estimates one or more genres in which each user is interested, and determines a recommended sales page limited by these genres. In the following description of the present embodiment, the same configurations and features as those of the first embodiment are not described.

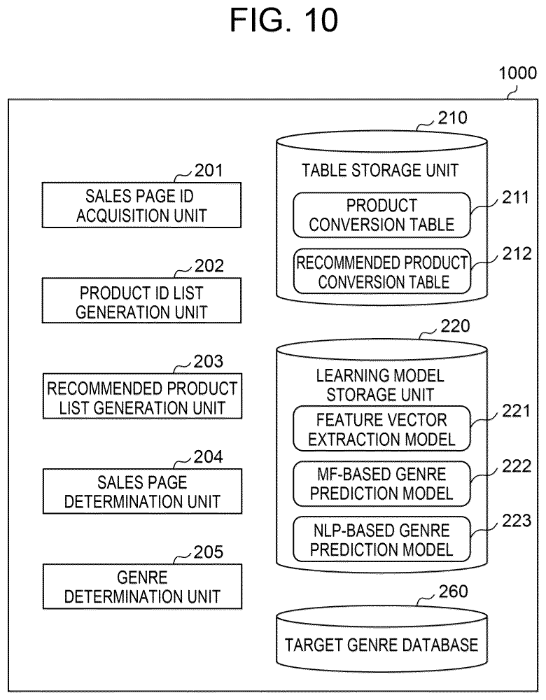

FIG. 10 shows an example of a functional configuration of an information processing apparatus 1000 according to the present embodiment. Compared to the information processing apparatus 10 according to the first embodiment described with reference to FIG. 2, the information processing apparatus 1000 additionally includes a genre determination unit 205 and a target genre database 260. Furthermore, the learning model storage unit 220 additionally includes an MF-based prediction model 222, which is a matrix factorization (MF)-based genre prediction model, and an NLP-based prediction model 223, which is a natural language processing (NLP)-based genre prediction model. Although not shown in FIG. 10, the information processing apparatus 1000 is connected to the e-commerce site server 11 via the network 13 as in FIG. 2.

The target genre database 260 stores information (hereafter referred to as “target genre information”) related to a plurality of target genres that are predetermined based on predetermined criteria. The target genre information stored in the target genre database 260 is generated by a processing unit (not shown) of the information processing apparatus 1000 or an external device, and is updated as needed. The target genre information may be target genre features that represent features of each of the target genres, or a target genre ID that identifies each of the target genres.

The MF-based prediction model 222 is a model that decomposes an evaluation value matrix of m (number of rows)×n (number of columns) (m and n are integers greater than or equal to 2) into two matrices by reducing the dimensionality using collaborative filtering. In the present embodiment, the MF-based prediction model 222 decomposes an evaluation value matrix with m user IDs and n genre IDs into a matrix representing user features and a matrix representing genre features. The NLP-based prediction model 223 is a natural language processing model that converts words into vector representations, such as Word2Vec. In the present embodiment, the NLP-based prediction model 223 converts a user ID and a genre ID into user features and genre features. Note that the MF-based prediction model 222 and the NLP-based prediction model 223 are trained models and may be trained by a learning unit (not shown) of the information processing apparatus 10.

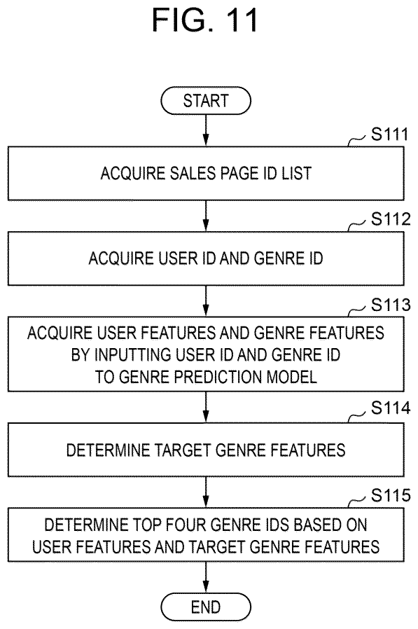

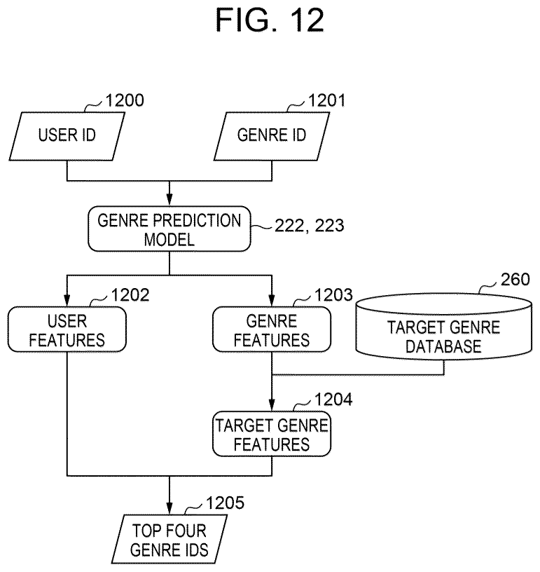

Processing performed by the genre determination unit 205 is described with reference to FIGS. 11 and 12. The genre determination unit 205 in the present embodiment determines, for each user, genre IDs of the top four genres (top four genre IDs) in which the user is interested. FIG. 11 is a flowchart of genre determination processing performed by the genre determination unit 205 according to the present embodiment. FIG. 12 is a conceptual diagram showing the flow of data in determining the top four genre IDs. Although processing by which the genre determination unit 205 determines the top four genre IDs is described in the present embodiment, the number of top genre IDs to be determined is not limited to four.

In step S111, the genre determination unit 205 acquires the time-series sales page ID list (see FIG. 3) stored in the sales page ID database 240 of the e-commerce site server 11. Next, in step S112, the genre determination unit 205 acquires a user ID and a genre ID (see FIG. 3) from the sales page ID list acquired in step S111. As mentioned above, each user ID is associated with user attributes of the user identified by this user ID. The genre ID is an ID that identifies the genre of a product being sold on the sales page identified by the corresponding sales page ID 302, as shown in FIG. 3. In FIG. 12, the user ID and the genre ID acquired by the genre determination unit 205 are denoted as a user ID 1200 and a genre ID 1201, respectively. Although the user ID 1200 and the genre ID 1201 are shown in FIG. 12, the genre determination unit 205 acquires a plurality of user IDs and a plurality of genre IDs by sequentially performing this acquisition processing.

In step S113, the genre determination unit 205 acquires user features 1202 representing the interest of the user and genre features 1203 representing feature of genres by inputting the user ID 1200 and a plurality of genre IDs 1201 to a trained genre prediction model. The genre prediction model used here is the MF-based prediction model 222 or the NLP-based prediction model 223. The user features 1202 and the genre features 1203 may be associated with the user ID 1200 and the genre IDs 1201, respectively.

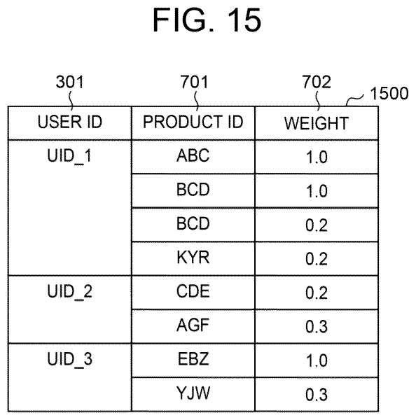

When using the MF-based prediction model 222, the genre determination unit 205 first generates as input data an evaluation value matrix with m user IDs and n genre IDs. In the example shown in FIG. 3, the number of user IDs is three (UID_1 to UID_3), and the number of genre IDs is five (g_1 to g_5). Thus, a 3×5 evaluation value matrix is generated. Values of elements of the evaluation value matrix may be set by referencing the time-series sales page ID list acquired in step S111. For example, the genre determination unit 205 references the time-series sales page ID list acquired in step S111, sets a predetermined value to genre IDs corresponding to each user ID, and sets zero (null value) to a genre ID that does not correspond to any user ID. Referring to FIG. 3, the genre determination unit 205 may set, in a column of user ID=UID_1, a predetermined value as the value of the elements with genre ID=g_1, g_3, and g_4, and set zero as the value of the element with genre ID=g_2 and g_5. Note that different values may be set to genre IDs corresponding to each user ID in accordance with the action type 303 in FIG. 3. For example, different values (e.g., later-described weights 702 shown in FIG. 15) may be set to “purchase”, “register as favorite”, and “view”.

Next, the genre determination unit 205 inputs the generated evaluation value matrix to the MF-based prediction model 222. The MF-based prediction model 222 reduces the dimensionality of the input evaluation value matrix to generate and output two matrices, i.e., a matrix representing user features and a matrix representing genre features. The matrix representing user features and the matrix representing genre features can be separated into the user features 1202 for each user ID and the genre features 1203 for each genre ID. The user features 1202 and the genre features 1203 are vector representations embedded in the common vector space and correspond to a user embedding and a genre embedding, respectively.

On the other hand, when using the NLP-based prediction model 223, the genre determination unit 205 inputs the user ID 1200 and the genre ID 1201 to the NLP-based prediction model 223. The NLP-based prediction model 223 converts the user ID and the genre ID into respective vector representations and outputs the resulting vector representations as user features and genre features. These user features and genre features are vector representations embedded in the common vector space and correspond to a user embedding and a genre embedding, respectively.

In step S114, the genre determination unit 205 determines target genre features 1204 based on the genre features 1203 and the target genre information stored in the target genre database 260. In this example, to ultimately determine the top four genre IDs, target genre information regarding five or more target genres, i.e., a greater number of target genres than the number of top genre IDs to be determined, is used. The genre determination unit 205 filters (selects) the genre features 1203 based on the target genre information, and determines target genre features 1204. When, for example, the target genre information is constituted by five target genre IDs, the genre determination unit 205 determines the genre features 1203 associated with these five target genre IDs as the target genre features 1204.

In step S115, the genre determination unit 205 determines top four genre IDs 1205 based on the user features 1202 and the target genre features 1204. The genre determination unit 205 determines the top four genre IDs 1205 in accordance with the similarity between the user features 1202 and the target genre features 1203. For example, cosine similarity is used as this similarity. As mentioned above, the cosine similarity is a measure of the similarity between two vectors in the common vector space. The genre determination unit 205 can determine that the larger the cosine value (−1 to +1) of an angle between the two vectors of the user features 1202 and the target genre features 1204, the higher the similarity is.

The top four genre IDs 1205 per user determined by the genre determination unit 205 are used in order to determine a sales page. For example, the top four genre IDs 1205 may be transmitted to the sales page ID acquisition unit 201. In this case, the sales page ID acquisition unit 201 may exclude genre IDs other than the top four genre IDs when acquiring a per-user sales page ID list such as that shown in FIG. 6. Alternatively, the top four genre IDs 1205 may be transmitted to the sales page determination unit 204. In this case, the sales page determination unit 204 may exclude genre IDs other than the top four genre IDs 1205 when generating a sales page ID list such as that shown in FIG. 9. Thus, recommended sales pages corresponding to the genre IDs included in the top four genre IDs 1205 are determined for each user.

According to the present embodiment, a recommended sales page for a product to be recommended is determined for one or more genres in which each user is estimated to be more interested, as described above. Thus, it is possible to appropriately determine the recommended sales page for a product to be recommended to each user that is limited to one or more genres in accordance with the user's interest.

### Third Embodiment

The information processing apparatus according to the above embodiments determines a sales page for a product to be recommended for each user based on information collected in response to a plurality of users performing predetermined actions on sales pages operated in an e-commerce mall. In the present embodiment, a description is given of processing for determining a default sales page to be presented to a user (hereinafter referred to as a “new user”) who accesses (visits) the e-commerce mall for the first time. Since the processing according to the present embodiment can also be performed by the information processing apparatus of either of the above-described embodiments, the processing will be described with reference to the information processing apparatus 10 shown in FIG. 2 and described in the first embodiment.

The sales page ID acquisition unit 201 acquires the time-series sales page ID list that has been collected by the e-commerce site server 11 and stored in the sales page ID database 240. In the present embodiment, the time-series sales page ID list is acquired in which the time-series sales page IDs are not sorted per user and that has been collected by the e-commerce site server 11 during a predetermined time period (e.g., a time period up to a predetermined time before the time of acquisition). An example of the acquired sales page ID list is as shown in FIG. 3. The sales page ID acquisition unit 201 may acquire the time-series sales page ID list every predetermined time or at a time when the new user accesses the e-commerce mall.

Next, the product ID list generation unit 202 generates a product ID list based on the time-series sales page ID list acquired by the sales page ID acquisition unit 201. The procedure for generating the product ID list is as described in the first embodiment, and may be performed using the product conversion table 211. In the processing up to this point, a list of product IDs that identify products corresponding to sales pages on which a plurality of users has performed actions within the predetermined time period is generated.

The sales page determination unit 204 determines a recommended sales page for each of one or more products to be recommended to the new user based on the product IDs included in the product ID list generated by the product ID list generation unit 202. For example, the sales page determination unit 204 converts the product IDs included in the product ID list into one or more sales page IDs using the product conversion table 211, and generates a recommended sales page ID list for the new user. The sales page determination unit 204 then determines sales pages identified by the recommended sales page IDs included in the recommended sales page ID list as sales pages to be recommended (presented) to the new user.

If the time-series sales page ID list is acquired by the sales page ID acquisition unit 201 every predetermined time, the sales page determination unit 204 sequentially generates a recommended sales page ID list. The sales page determination unit 204 may then determine sales pages to be recommended to the new user based on the recommended sales page ID list generated at a time close to the time when the new user accessed the e-commerce mall. If the time-series sales page ID list is acquired by the sales page ID acquisition unit 201 at the time when the new user accesses the e-commerce mall, the sales page determination unit 204 generates a recommended sales page ID list corresponding to that time. The sales page determination unit 204 may then determine sales pages to be recommended to the new user based on the generated recommended sales page ID list.

The sales page determination unit 204 may specify a user that is not included in view history information regarding the e-commerce mall acquired by the e-commerce site server 11 as a new user. Alternatively, the new user is not limited to a user that accesses the e-commerce mall for the first time, and the sales page determination unit 204 may specify as a new user a user other than users included in the time-series sales page ID list acquired by the sales page ID acquisition unit 201.

Note that the time-series sales page ID list acquired by the sales page ID acquisition unit 201 is not limited to the time-series sales page ID list acquired by the e-commerce site server 11 within a predetermined period. For example, the sales page ID acquisition unit 201 may acquire a list of time-series sales page IDs associated with a limited number of times of one or more predetermined action types. Specifically, the sales page ID acquisition unit 201 may limit the action type to the “purchase” action, and acquire from the e-commerce site server 11 a list of time-series sales page IDs associated with a predetermined number of times of the “purchase” actions. In addition, the sales page ID acquisition unit 201 may generate a time-series sales page ID list acquired for one or more users having user attributes similar to those of the new user from the time-series sales page ID list acquired by the e-commerce site server 11, and output the generated list to the product ID list generation unit 202.

According to the present embodiment, it is thus possible to present recommended sales pages to a new user that accesses the e-commerce mall for the first time, based on sales pages associated with previously collected action histories of other users. This allows the new user to view sales pages of products for which actions such as purchase have been performed more frequently in the e-commerce mall, thereby increasing their purchasing motivation.

### Fourth Embodiment

In the first embodiment, the recommended product list generation unit 203 generates the recommended product ID list using the feature vector extraction model 221 stored in the learning model storage unit 220, while in the present embodiment, the recommended product list generation unit 203 generates the list on a rule basis. Specifically, the recommended product list generation unit 203 generates the recommended product ID list using a recommended product conversion table 212, which is described below. In the following description of the present embodiment, the same configurations and features as those of the first embodiment are not described. The above-described second and third embodiments can also be applied to the present embodiment.

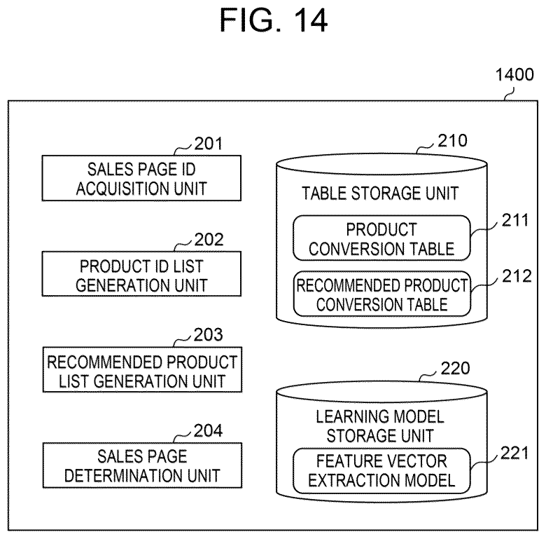

FIG. 14 shows an example of a functional configuration of an information processing apparatus 1400 according to the present embodiment. Compared to the information processing apparatus 10 according to the first embodiment described with reference to FIG. 2, the table storage unit 210 of the information processing apparatus 1400 has a recommended product conversion table 212. The recommended product conversion table 212 is a table that associates a product ID with recommended product IDs (recommended product identification information) that identify one or more products to be recommended based on the products identified by the product ID. In the recommended product conversion table 212, one or more recommended product IDs are associated with a product ID based on past records. For example, in the recommended product conversion table 212, product IDs of products purchased by a user group having similar user attributes in the e-commerce mall are associated with product IDs (recommended product IDs) of one or more other products purchased by users belonging to this group at the same time as or after the purchase of the initial products. If there are a large number of such other products, the product IDs of a predetermined number of products purchased by a high proportion of users in the user group (i.e., purchased by many users in the user group) may be listed as recommended product IDs. The product conversion table 211 and the recommended product conversion table 212 are generated and updated as needed by a processing unit (not shown) of the information processing apparatus 10 or an external device. Note that the information processing apparatus 1400 may also perform the processing described in the first embodiment at the same time. In this case, the information processing apparatus 1400 may determine sales pages for one or more recommended product IDs determined through both types of processing.

Processing performed by the information processing apparatus 10 according to the present embodiment is described with reference to FIG. 5. In FIG. 5, processing in steps S51 and S52 is as described in the first embodiment. In step S53, the recommended product list generation unit 203 generates a recommended product list based on the recommended product conversion table 212. For example, the recommended product list generation unit 203 references the recommended product conversion table 212 to determine a recommended product ID corresponding to each product ID included in the product ID list 70 shown in FIG. 7, and generates a recommended product ID list.

In the case where, as optional processing, the product ID list generation unit 202 in step S52 applies a weight indicating an interest level of the user according to the action type to each product ID, the recommended product list generation unit 203 in step S53 may generate a recommended product ID list based on the weight. For example, the “purchase” action on a product is an action of actually acquiring the product and can be considered as an action indicating a higher interest level of the user than the “view” and “register as favorite” actions. The “register as favorite” action on a product is an action of facilitating re-accessing a sales page of the corresponding product and can be considered as an action indicating a higher interest level of the user than the “view” action. The weight corresponding to the interest level of the user can thus be associated with each product ID.

FIG. 15 shows an example of a list 1500 obtained by adding a weight 702 corresponding to the action type to the per-user product ID list 70 shown in FIG. 7. In the example shown in FIG. 15, a weight of 1.0 is applied to a product ID corresponding to “purchase”, a weight of 0.3 is applied to a product ID corresponding to “register as favorite”, and a weight of 0.2 is applied to a product ID corresponding to “view”, based on the interest level of the user. Note that different weights may be applied to product IDs of the same action type in accordance with the action date and time 304 in the per-user sales page ID list 60 corresponding to the product ID list 70. For example, it can be considered that the “purchase” action performed on the newer date and time indicates a higher interest level of the user than the “purchase” action performed on the older date and time.” Therefore, a greater weight may be applied to the “purchase” action performed on the newer date and time than to the “purchase” action performed on the older date and time. For example, a weight for an action performed within a first time period backward from the date and time when the sales page ID list 30 serving as a basis of the sales page ID list 60 was obtained may be multiplied by a factor of 1, a weight for an action performed within a second time period backward from the first period may be multiplied by a factor of 0.8, and a weight for an action performed before the second period may be multiplied by a factor of 0.5. If a plurality of identical product IDs are listed for the same user, as in the case of the product ID 701=“BCD” in the product ID list 70, and a weight is applied to each of those product IDs, the summed weight may be applied to that product ID.

When the weight corresponding to the action type is applied (the weight 702 shown in FIG. 15), the recommended product list generation unit 203 can also determine the recommended product ID based on this weight. For example, if, in the recommended product conversion table 212, a plurality of recommended product IDs correspond to one product ID, the recommended product list generation unit 203 may determine more recommended product IDs for a product IDs having a higher weight.

### MODIFICATIONS

In the above-described embodiment, the sales page ID acquisition unit 201 acquires a time-series sales page ID list, and the product ID list generation unit 202 generates a product ID list based on the time-series sales page ID list. However, the e-commerce site server 11 may alternatively generate the product ID list. In this case, the product ID list generation unit 202 may acquire the product ID list generated by the e-commerce site server 11.

In the example described in the fourth embodiment, when a weight corresponding to the action type is applied, the recommended product list generation unit 203 also determines a recommended product ID based on this weight. However, the weight may be used in other processing. For example, a configuration may be employed in which the sales page determination unit 204 determines recommended sales pages, and instruct the e-commerce site server 11 to display a recommended sales page with a greater weight in a different display mode (e.g., so as to enhance the visual effect) from that of the other recommended sales pages.

The effect exhibited by the above-described embodiments and the modifications is described with reference to FIGS. 13A and 13C. In the screen 1300 shown in FIG. 13A, a plurality of products are sold on respective different sales pages. Meanwhile, in the screen 1320 shown in FIG. 13C, the product 1308 is sold on the sales pages 1306 and 1307. In such a case, whether a user purchases the product 1308 on the sales page 1306 or the sales page 1307, the purchase action is associated with the product 1308. This allows actions to be accurately counted for each product, making it possible to determine an appropriate product to be recommended to the user and a sales page for the recommended product.

Further, when a plurality of candidate recommended sales pages are determined for one product, one (unique) recommended sales page is determined for the product based on an evaluation index such as a CVR. By determining a recommended sales page based on the evaluation index, a sales page for a store that is highly rated by a plurality of users is determined, which can improve usability and purchasing motivation of users.

The disclosure includes the following embodiments.
[1] An information processing apparatus including: an acquisition unit configured to acquire a list of sales page identification information identifying each sales page for one or more products associated with each user; a conversion unit configured to convert the list of sales page identification information into a list of product identification information identifying a product; a generation unit configured to generate a recommended product list including recommended product identification information identifying each of one or more products to be recommended to the user, based on the list of product identification information; and a determination unit configured to determine a sales page for each of the one or more products to be recommended to the user, based on one or more pieces of recommended product identification information included in the recommended product list.
[2] The information processing apparatus according to [1], wherein the determination unit determines a unique sales page for each of one or more products identified by the one or more pieces of recommended product identification information.
[3] The information processing apparatus according to [2], wherein the determination unit specifies one or more sales pages selling the one or more products identified by the one or more pieces of recommended product identification information, and determines the unique sales page based on the one or more specified sales pages.
[4] The information processing apparatus according to [3], wherein if the determination unit specifies one sales page selling a product identified by the recommended product identification information, the determination unit determines the specified sales page as the unique sales page, and if the determination unit specifies a plurality of sales pages selling a product identified by the recommended product identification information, the determination unit determines the unique sales page out of the plurality of specified sales pages based on an evaluation index associated with each of the plurality of identified sales pages.
[5] The information processing apparatus according to [4], wherein the evaluation index includes a conversion rate (CVR) for each of the plurality of specified sales pages.
[6] The information processing apparatus according to [4] or [5], wherein the evaluation index includes an evaluation score given by a user to each of the plurality of specified sales pages.
[7] The information processing apparatus according to any one of [1] to [6], further including: a conversion unit configured to convert, for the user, product identification information included in the list of product identification information into a user vector representation using a machine learning model, wherein the generation unit determines, as the recommended product identification information, one or more pieces of product identification information corresponding to one or more vector representations each having a cosine similarity higher than a predetermined threshold with the user vector representation in a common vector space where a plurality of vector representations of the product identification information exist.
[8] The information processing apparatus according to any one of [1] to [7], further including: a selection unit configured to select one or more genres in which the user shows an interest, wherein the acquisition unit acquires the list of sales page identification information for the one or more genres selected for the user.
[9] The information processing apparatus according to [8], wherein the selection unit selects one or more genres for the user using a matrix factorization (MF)-based machine learning model.
[10] The information processing apparatus according to [8], wherein the selection unit selects one or more genres for the user using a natural language processing-based machine learning model.
[11] information processing apparatus according to any one of [1] to [10], the determination unit further determines a sales page for each of one or more products to be recommended to another user based on the list of product identification information.

What is claimed is:

1. An information processing apparatus comprising:
an acquisition unit configured to acquire a list of sales page identification information identifying each sales page for one or more products associated with each user;
a conversion unit configured to convert the list of sales page identification information into a list of product identification information identifying a product;
a generation unit configured to generate a recommended product list including recommended product identification information identifying each of one or more products to be recommended to the user, based on the list of product identification information; and
a determination unit configured to determine a sales page for each of the one or more products to be recommended to the user, based on one or more pieces of recommended product identification information included in the recommended product list.

2. The information processing apparatus according to claim 1,
wherein the determination unit determines a unique sales page for each of one or more products identified by the one or more pieces of recommended product identification information.

3. The information processing apparatus according to claim 2,
wherein the determination unit specifies one or more sales pages selling the one or more products identified by the one or more pieces of recommended product identification information, and determines the unique sales page based on the one or more specified sales pages.

4. The information processing apparatus according to claim 3,
wherein if the determination unit specifies one sales page selling a product identified by the recommended product identification information, the determination unit determines the specified sales page as the unique sales page, and
if the determination unit specifies a plurality of sales pages selling a product identified by the recommended product identification information, the determination unit determines the unique sales page out of the plurality of specified sales pages based on an evaluation index associated with each of the plurality of identified sales pages.

5. The information processing apparatus according to claim 4,
wherein the evaluation index includes a conversion rate (CVR) for each of the plurality of specified sales pages.

6. The information processing apparatus according to claim 4,
wherein the evaluation index includes an evaluation score given by a user to each of the plurality of specified sales pages.

7. The information processing apparatus according to claim 1, further comprising:
a conversion unit configured to convert, for the user, product identification information included in the list of product identification information into a user vector representation using a machine learning model,
wherein the generation unit determines, as the recommended product identification information, one or more pieces of product identification information corresponding to one or more vector representations each having a cosine similarity higher than a predetermined threshold with the user vector representation in a common vector space where a plurality of vector representations of the product identification information exist.

8. The information processing apparatus according to claim 1, further comprising:
a selection unit configured to select one or more genres in which the user shows an interest,
wherein the acquisition unit acquires the list of sales page identification information for the one or more genres selected for the user.

9. The information processing apparatus according to claim 8,
wherein the selection unit selects one or more genres for the user using a matrix factorization (MF)-based machine learning model.

10. The information processing apparatus according to claim 8,
wherein the selection unit selects one or more genres for the user using a natural language processing-based machine learning model.

11. The information processing apparatus according to claim 1,
the determination unit further determines a sales page for each of one or more products to be recommended to another user based on the list of product identification information.

12. An information processing method to be performed by an information processing apparatus, the method comprising:
an acquisition step of acquiring a list of sales page identification information identifying each sales page for one or more products associated with each user;
a conversion step of converting the list of sales page identification information into a list of product identification information identifying a product;
a generation step of generating a recommended product list including recommended product identification information identifying each of one or more products to be recommended to the user, based on the list of product identification information; and
a determination step of determining a sales page for each of the one or more products to be recommended to the user, based on one or more pieces of recommended product identification information included in the recommended product list.

13. A non-transitory computer readable medium storing an information processing program for causing a computer to perform information processing including:
acquisition processing of acquiring a list of sales page identification information identifying each sales page for one or more products associated with each user;
conversion processing of converting the list of sales page identification information into a list of product identification information identifying a product;
generation processing of generating a recommended product list including recommended product identification information identifying each of one or more products to be recommended to the user, based on the list of product identification information; and
determination processing of determining a sales page for each of the one or more products to be recommended to the user, based on one or more pieces of recommended product identification information included in the recommended product list.
